(19) United States
(12) Patent Application Publication
(10) Pub. No.: US 2004/0008274 A1
(43) Pub. Date: Jan. 15, 2004

(54) Imaging device and illuminating device

(76) Inventors: Hideo Ikari, Kanagawa (JP); Yoshinobu Shibayama, Kanagawa (JP)

Correspondence Address: ROBIN BLECKER & DALEY, 2ND FLOOR, 330 MADISON AVENUE, NEW YORK, NY, 10017, US

(21) Appl. No.: 10/616,577

(22) Filed: Jul. 10, 2003

(30) Foreign Application Priority Data
Jul. 17, 2001 (JP) 208446/2002
Jun. 26, 2003 (JP) 182776/2003

(51) Int. Cl. H04N 5/222

(52) U.S. Cl. 348/370

(57) ABSTRACT

An imaging device includes a mode setting member which allows a shooting mode to be selected from a plurality of shooting modes, a first trigger member for shooting still images, and a second trigger member for shooting motion images. The mode setting member makes at least a first shooting mode and second shooting mode available. In the first shooting mode, a still image is shot by causing a first light emitter to emit light continuously when a first operation signal from the first trigger member is detected and causing the first light emitter to stop emitting light and causing a second light emitter to emit light when a second operation signal from the first trigger member is detected. In the second shooting mode, when an operation signal from the second trigger member is detected, moving images are started to be shot while a first light emitter keeps emitting light continuously.

### BACKGROUND OF THE INVENTION

1. Field of the Invention

The present invention relates to an imaging device, such as a video camera, capable of shooting motion images and still images or to an illuminating device which emits light in response to commands from the imaging device.

2. Related Background Art

When shooting still images with an imaging device such as a camcorder capable of motion imaging, if the luminance of the subject is low, a built-in flash unit of the imaging device or a separate flash unit is fired to increase the luminance of the subject as is the case with an electronic still camera. When a person is photographed with a flash unit fired, light emitted from the flash unit is reflected by the retinas in the person's eye balls and the reflected light may cause the person's eye balls to appear red (hereinafter, this phenomenon will be referred to as red-eye).

To reduce the red-eye, the pupils of the person photographed can be caused to contract to make the light reflected by the retinas less prone to be photographed.

A method for this involves providing a red-eye reduction lamp separate from the flash unit to illuminate the subject just before shooting.

Another method involves firing a flash unit for a few milliseconds (hereinafter referred to as preflashing) just before shooting, obviating the need to provide an illuminating device (hereinafter referred to as a red-eye reduction lamp) for red-eye reduction.

A photographic apparatus which reduces red-eye by preflashing a flash unit for a few milliseconds before shooting requires a complicated control circuit because energy stored in a capacitor for the flash unit must be divided between the preflashing and the main flashing for still imaging.

Since the energy for flashing stored in the capacitor is divided between the preflashing and main flashing, the energy available for the main flashing is decreased, resulting in a reduced flash range. To secure sufficient energy for the main flashing, a large capacitor must be used to store more energy.

### SUMMARY OF THE INVENTION

The present invention has been made under the above circumstances. Its object is to provide an imaging device or flash unit which can achieve red-eye reduction without using a red-eye reduction lamp or preflashing the flash unit.

### BRIEF DESCRIPTION OF THE DRAWINGS

FIG. 1 is a right front perspective view of a video camera according to an embodiment of the present invention;

FIG. 2 is a left front perspective view of the video camera according to the embodiment of the present invention;

FIG. 3 is a left front perspective view showing how the video camera according to the embodiment of the present invention is held;

FIG. 4 is a right rear perspective view of the video camera according to the embodiment of the present invention;

FIG. 5 is a right rear perspective view showing how the video camera according to the embodiment of the present invention is held;

FIG. 6 is a block diagram showing the video camera according to the embodiment of the present invention;

FIG. 7 is a flowchart showing procedures for shooting motion images according to the embodiment of the present invention;

FIG. 8 is comprised of FIGS. 8A and 8B showing flowcharts of procedures for shooting still images according to the embodiment of the present invention;

FIG. 9 is a diagram showing a menu for selecting a shooting mode on the video camera according to the embodiment of the present invention;

FIG. 10 is a diagram showing the order in which flash modes are selected on the video camera according to the embodiment of the present invention;

FIG. 11 is a diagram showing an example of how a motion image is shot by illuminating a subject with a subject illuminating light built into the camera according to the embodiment of the present invention;

FIG. 12 is a partial sectional view of the subject illuminating light built into the body of the video camera according to the embodiment of the present invention;

FIG. 13 is a block diagram of a video camera according to another embodiment of the present invention;

FIG. 14 is an exploded perspective view of a manual focusing unit for the lens of the video camera according to the embodiment of the present invention;

FIG. 15 is a sectional assembly diagram of the manual focusing unit of the video camera according to the embodiment of the present invention;

FIG. 16 is an exploded view of major parts of a detector of the video camera according to the embodiment of the present invention;

FIG. 17 is an exploded perspective view of the major parts of the detector of the video camera according to the embodiment of the present invention; and

FIGS. 18A and 18B are diagrams showing pulse signals obtained from a pair of photoreflectors when an operating member of the video camera according to the embodiment of the present invention is rotated.

### DESCRIPTION OF THE PREFERRED EMBODIMENTS

Embodiments of the present invention will be described below with reference to the drawings. A video camera which is an imaging device according to an embodiment of the present invention is capable of shooting motion images and still images.

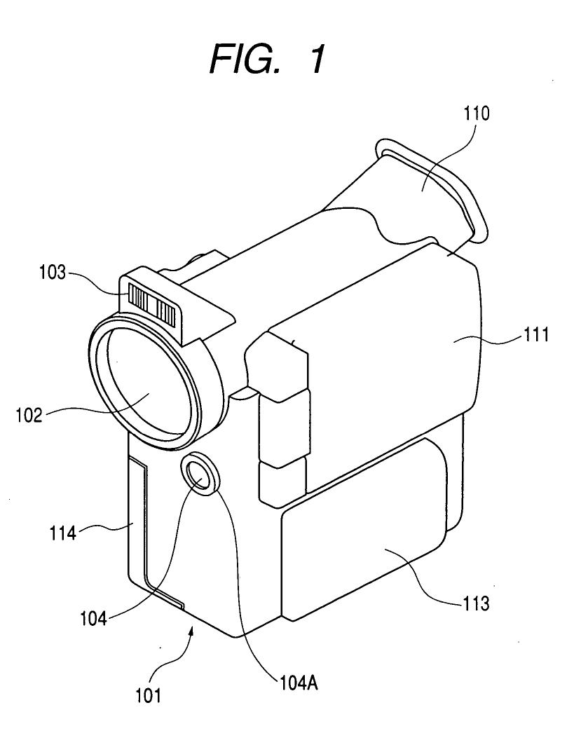

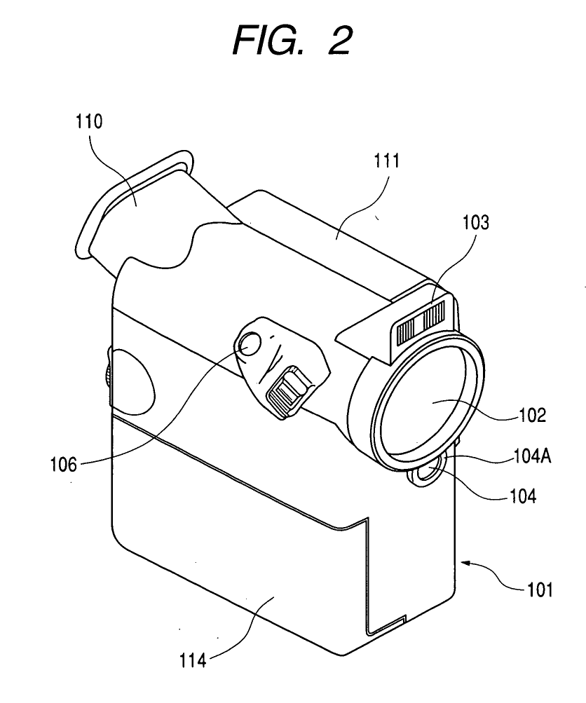

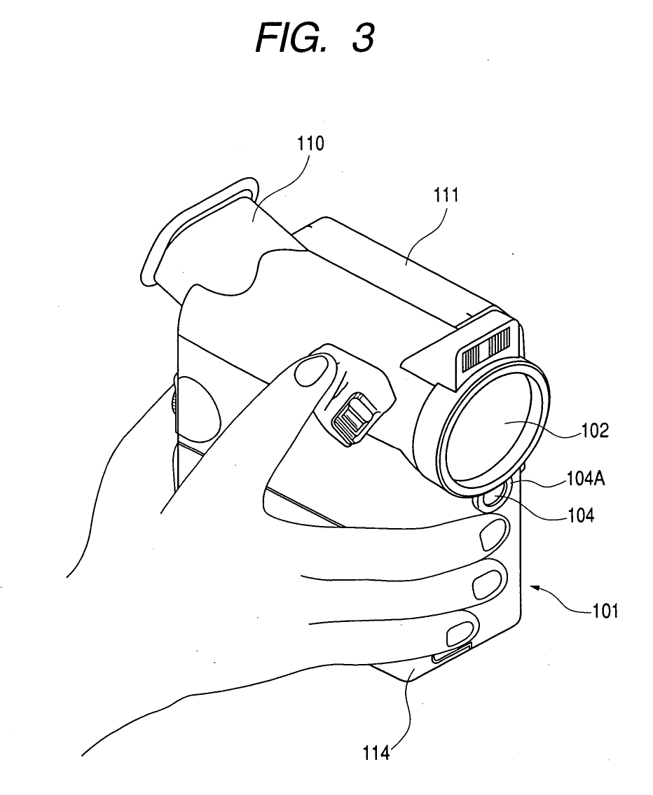

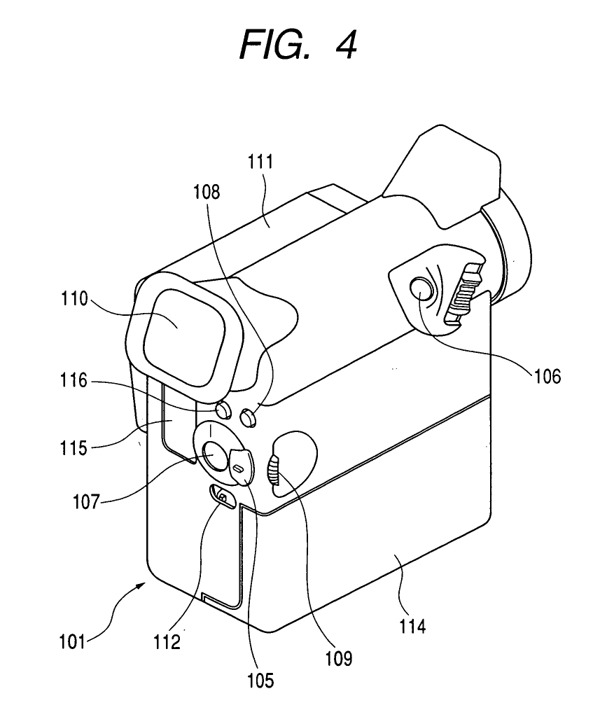

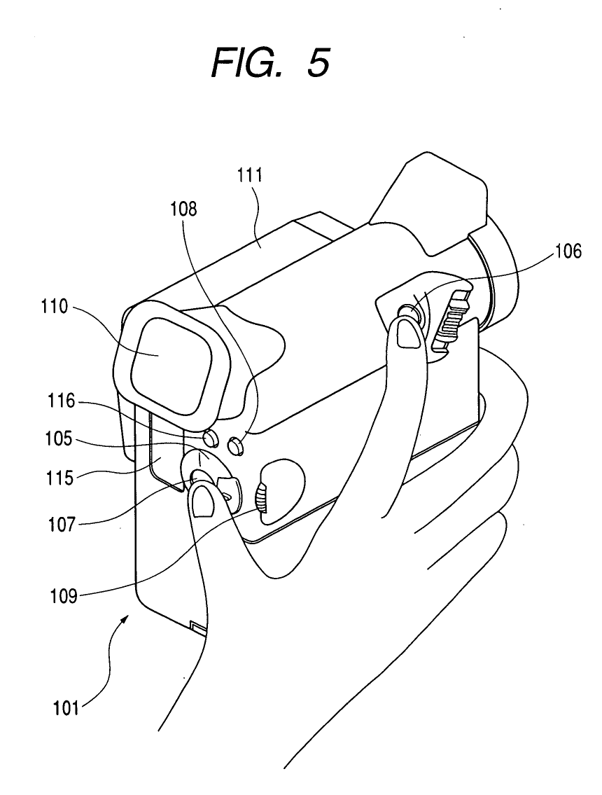

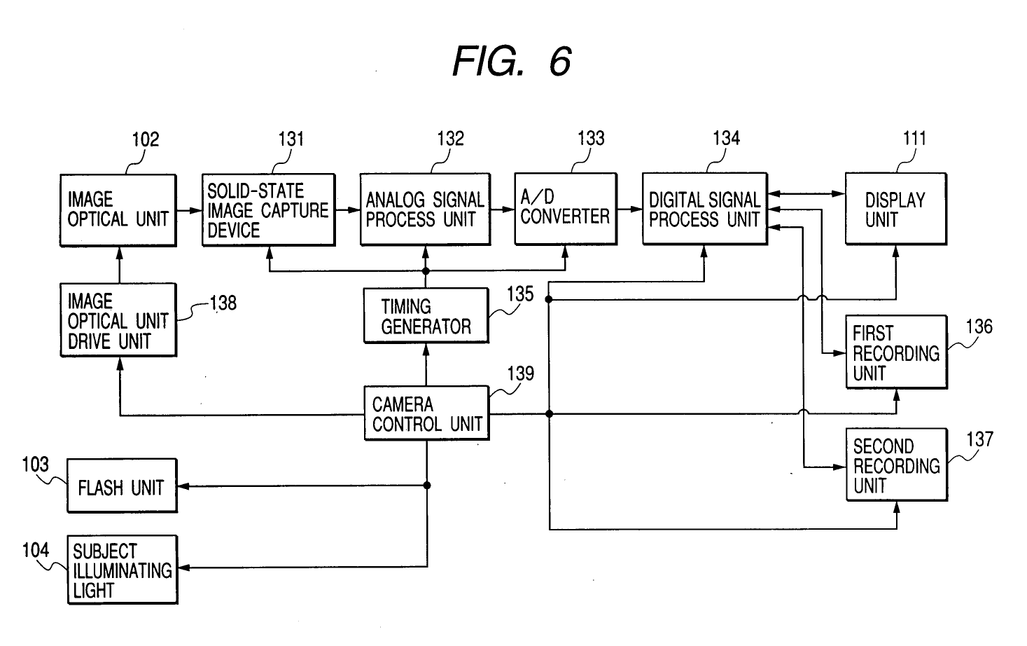

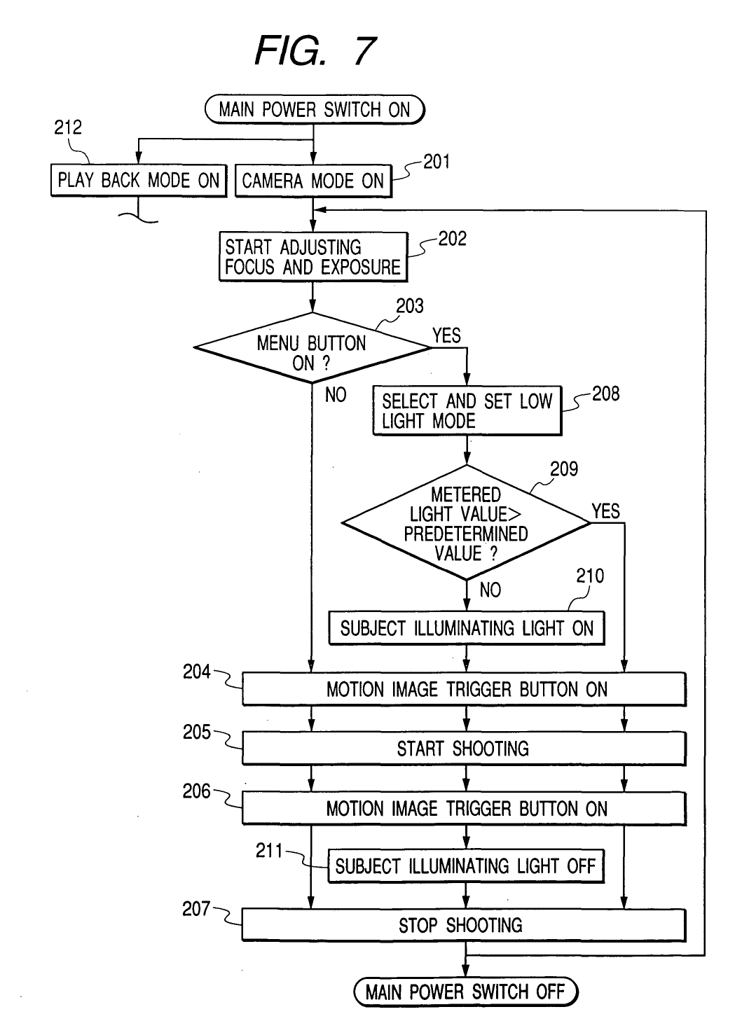

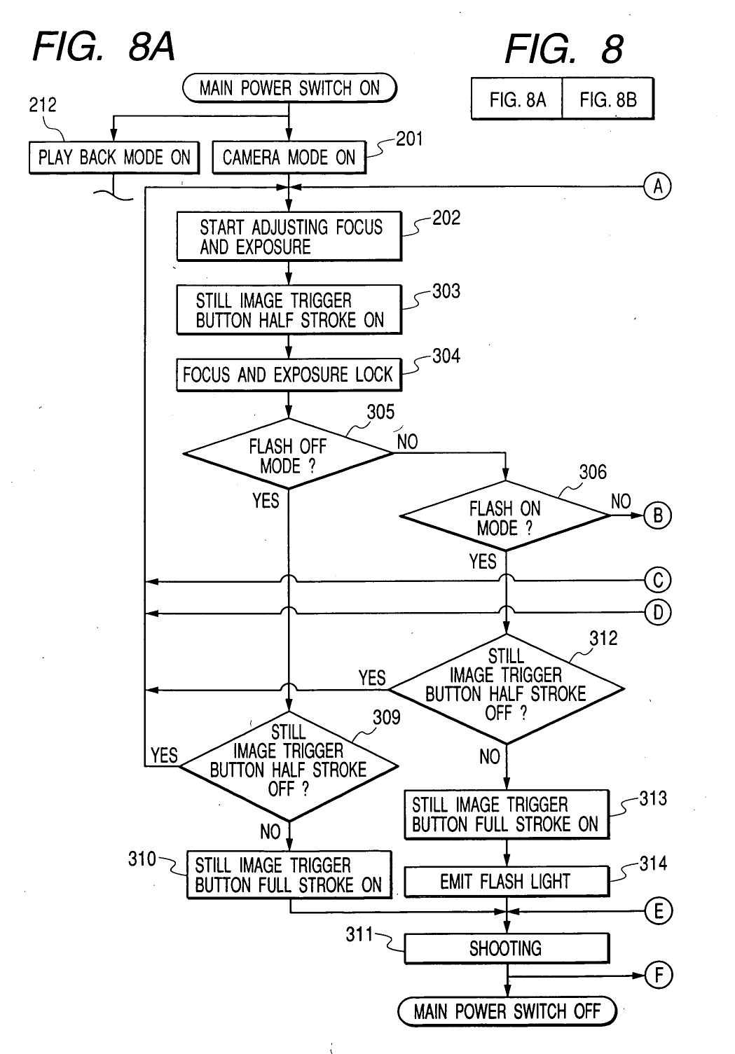

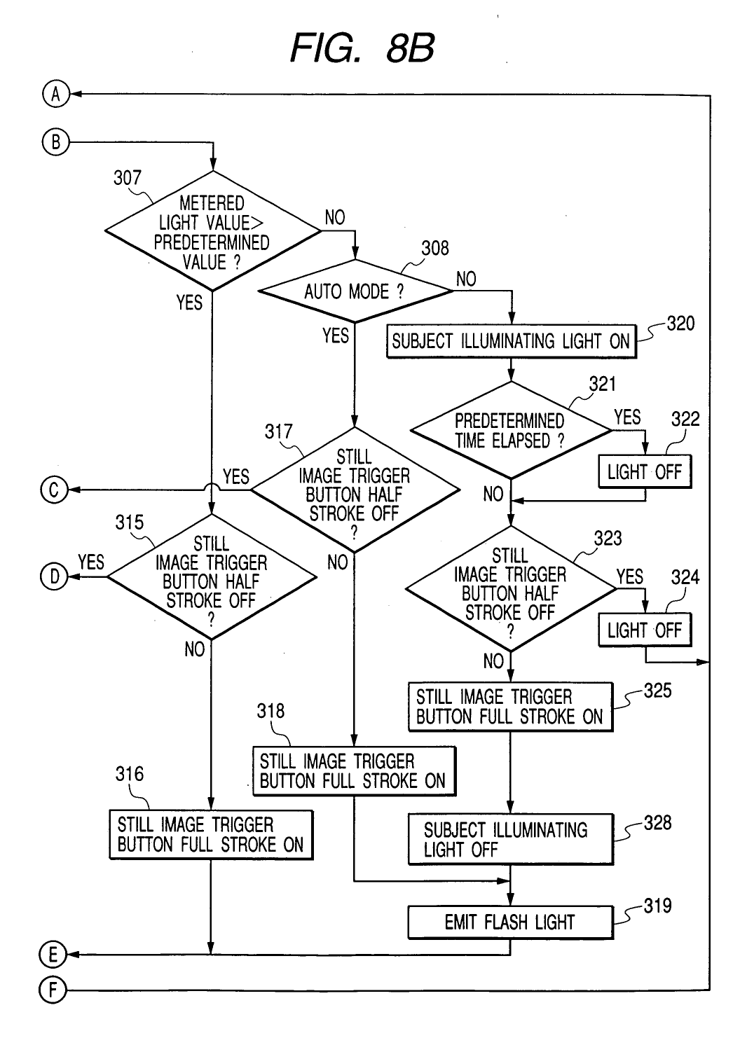

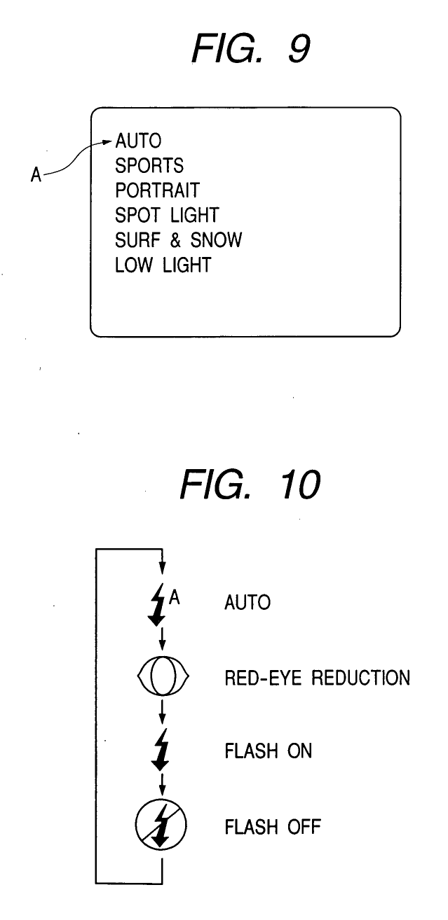

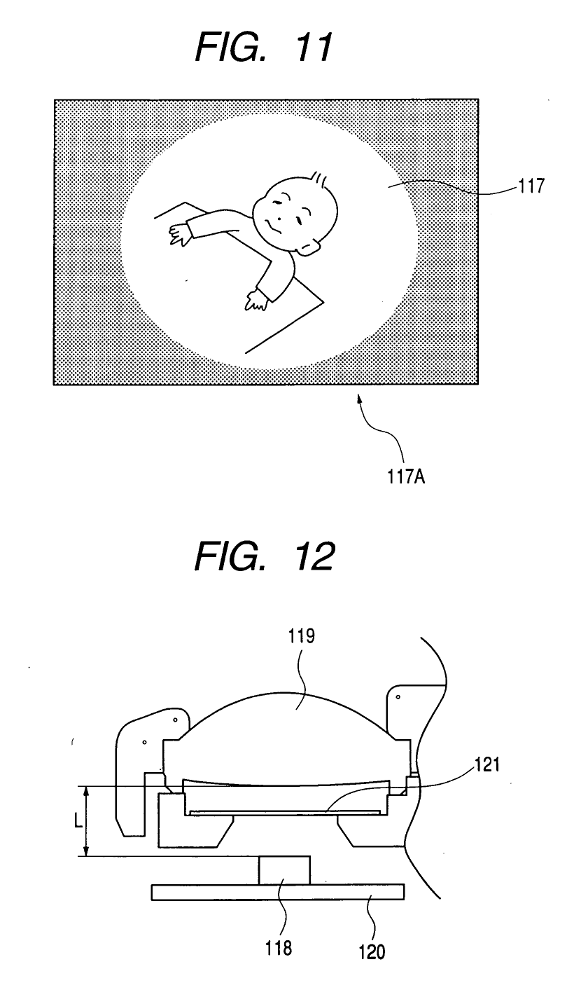

FIG. 1 is a right front perspective view of the video camera which is the imaging device according to this embodiment; FIG. 2 is a left front perspective view of the video camera according to this embodiment; FIG. 3 is a left front perspective view showing how the video camera according to this embodiment is held by a user; FIG. 4 is a right rear perspective view of the video camera according to this embodiment; FIG. 5 is a right rear perspective view showing how the video camera according to this embodiment is held by the user; FIG. 6 is a block diagram showing the video camera according to this embodiment; FIG. 7 is a flowchart showing procedures for shooting motion images according to this embodiment; FIGS. 8A and 8B are flowcharts showing procedures for shooting still images according to this embodiment; FIG. 9 is a diagram showing a menu for selecting a shooting mode on the video camera according to this embodiment; FIG. 10 is a diagram showing the order in which flash modes are selected on the video camera according to this embodiment; FIG. 11 is a diagram showing an example of how a motion image is shot by illuminating a subject with a subject illuminating light built into the camera according to this embodiment; and FIG. 12 is a partial sectional view of the subject illuminating light built into the body of the video camera according to this embodiment.

In FIGS. 1 to 12, reference numeral 101 denotes the video camera body, i.e., the imaging device which is capable of shooting motion images and still images and incorporates two illuminating devices—a flash unit and subject illuminating light. Reference numeral 102 denotes an image optical unit which includes a photographic lens that receives reflected light from a subject and leads it to an image capture device in the video camera, 103 denotes a light emitter which is the flash unit installed above the photographic lens 102 to illuminate the subject, and 104 denotes the subject illuminating light which is located to the lower right of the photographic lens when viewed from the front and consists of a high-intensity LED.

The subject illuminating light 104 is installed at a location less liable to be covered by fingers when the video camera body 101 is held by the user, for example, as shown in FIG. 3. Besides, a bank 104A is formed around the subject illuminating light 104 to alert the user by means of the elevation of the bank 104A if a finger covers the subject illuminating light 104 and warn the user to take the finger off the subject illuminating light 104.

Reference numeral 105 denotes a main power switch of the video camera body 101. Rotating the main power switch 105 counterclockwise by a predetermined amount from a neutral position shown in FIG. 4 puts the video camera in Camera mode which allows the user to shoot motion images and still images. On the other hand, rotating the main power switch 105 clockwise by a predetermined amount from a neutral position puts the video camera in Image Playback mode which allows the user to played back recorded images.

Reference numeral 106 denotes a still image trigger button, which is used to shoot still images on the video camera and causes one of two signals—first signal and second signal—to be output depending on how far it is pressed. Pressing the still image trigger button 106 half-stroke causes the first signal to be output and pressing the still image trigger button 106 full-stroke causes the second signal to be output. Reference numeral 107 denotes a motion image trigger button, which is used to shoot motion images on the video camera.

Reference numeral 108 denotes a menu button which makes shooting modes available. Pressing the menu button 108 makes appropriate shooting modes available according to shooting conditions. Reference numeral 109 denotes a dial switch used to switch among the shooting modes. When the menu button 108 is pressed, available shooting modes are displayed in a view finder 110 or on an LCD panel 111 as shown in FIG. 9. In this condition, the user can select a desired shooting mode by moving an index A with the dial switch 109.

Reference numeral 112 denotes a recording media selector switch, which allows the user to switch between recording media such as magnetic tape used to record motion images and recording media such as memory cards used to record still images. Reference numeral 113 denotes a battery which supplies power to the video camera body 101, reference numeral 114 denotes an openable cover for mounting magnetic tape, and reference numeral 115 denotes a card cover for mounting another type of recording medium, a memory card.

Reference numeral 116 denotes a flash mode button which makes flash modes available. Each time the flash mode button 116 is pressed, the selected flash mode changes. The selected flash mode is displayed in the view finder 110 or on the LCD panel 111 and each time the flash mode button 116 is pressed, the display changes as shown in FIG. 10. Auto mode makes a microcomputer, a controller in the video camera, judge whether a flash should be fired according to the luminance value of the subject and makes a light emitted if it is judged that a flash should be fired. Red-Eye Reduction mode makes the microcomputer in the video camera judge whether a flash should be fired according to the luminance value of the subject as is the case with the Auto mode, but differs from the Auto mode in that a light emitted to reduce red-eye before the main flashing for still-image shooting. Flash ON mode forces a flash to be fired regardless of the luminance of the subject. Flash OFF mode prohibits a flash from being fired regardless of the luminance of the subject.

FIG. 11 is a diagram showing an example of how an image is shot using the subject illuminating light 104. It shows a child's sleeping face photographed in a completely dark room. Out of a rectangular photographic frame 117A, an almost circular illuminated area 117 is illuminated by the subject illuminating light 104. The size of the illuminated area 117 depends on the light distribution angle of a light-emitting chip 118 and the curvature of a condensing lens 119 in the subject illuminating light 104 shown in FIG. 12, which is a sectional view of the subject illuminating light 104. The light-emitting chip 118 is mounted on a wiring board 120. The distance L may vary due to looseness in the installation of the light-emitting chip 118 or due to installation error of the wiring board 120 or condensing lens 119. With the curvature of the condensing lens 119 according to the present invention, the light gathering area of the condensing lens 119 widens as the distance L decreases, and the brightness decreases as the illuminated area 117 increases. Conversely, the light gathering area of the condensing lens 119 narrows as the distance L increases, and the brightness increases as the illuminated area 117 decreases.

At this time, a large difference in brightness between the illuminated area 117 and photographic frame 117A will result in degraded image quality due to over- or under-exposure because automatic exposure control by the video camera body 101 will make light part (within the illuminated area 117) affected by dark part (outside the illuminated area 117) or vise versa. To prevent the degradation of image quality caused as the automatic exposure control by the video camera body 101 makes the dark part affect the light part or vise versa, a diffusion sheet 121 is installed between the condensing lens 119 and light-emitting chip 118 to create a blurred circular contour in the illuminated area 117 and thereby decrease the brightness difference. The diffusion sheet 121 used has a high light transmittance to minimize light transmission loss through the diffusion sheet 121.

FIG. 6 is a block diagram showing the video camera according to this embodiment. Reference numeral 102 denotes the photographic lens shown in FIG. 1 and reference numeral 131 denotes a solidstate image capture device, such as a CCD, which converts the subject image entering through the photographic lens 102 into an electrical signal. Reference numeral 132 denotes an analog signal process unit and reference numeral 133 denotes an A/D converter. Analog image signals outputted from the solid-state image capture device 131 are processed by the analog signal process unit 132, and then converted into digital image signal by the A/D converter 133. Reference numeral 134 denotes a digital signal process unit which performs luminance signal processing and color signal processing on digitized image signals. Reference numeral 135 denotes a timing generator which supplies various driving pulses and timing pulses to the solid-state image capture device 131, analog signal process unit 132 and A/D converter 133. Reference numeral 111 denotes a display unit which corresponds to the LCD panel 111 in FIG. 1. Reference numeral 136 denotes a first recording unit which records motion images on a recording medium such as magnetic tape while reference numeral 137 denotes a second recording unit which mainly records motion images on a recording medium such as a memory card. Reference numeral 138 denotes an image optical unit drive unit which drives the photographic lens 102 according to shooting mode and shooting conditions. Reference numeral 103 denotes the flash unit and reference numeral 104 denotes the subject illuminating light. Reference numeral 139 denotes a camera control unit which integrally controls the timing generator 135, image optical unit drive unit 138, digital signal process unit 134, display unit 111, first recording unit 136, second recording unit 137, flash unit 103 and subject illuminating light 104 and gives instructions so that components necessary for motion-image shooting, still-image shooting, image recording, and image playback can work in conjunction properly.

Motion-image shooting on the video camera with the above configuration will be described with reference to the flowchart in FIG. 7. When the power is off, if the user turns on the main power by rotating the main power switch 105 counterclockwise by a predetermined amount and sets the Camera mode (Step 201), the camera control unit 139 instructs the image optical unit drive unit 138 to adjust the focus of the photographic lens as well as to adjust the exposure using a diaphragm mechanism in the lens-barrel, according to the distance of the subject from the video camera and the luminance of the subject (Step 202). When the menu button 108 is pressed (Step 203), the display for shooting mode selection shown in FIGS. 8A and 8B is brought up in the view finder 110 or on the LCD panel 111. As the shooting mode selection dial switch 109 is rotated in this condition, the index A beside the list of shooting modes in FIG. 9 moves up and down. As the user presses the menu button 108 again when the index A is aligned with the desired shooting mode, the selected shooting mode is applied.

According to this embodiment, when the menu button 108 is pressed, the shooting mode menu defaults to AUTO and thus the index A is placed beside AUTO. Besides, SPORTS, PORTRAIT, SPOTLIGHT, SURF & SNOW and LOW LIGHT are displayed as shooting modes.

If the menu button for selecting a shooting mode is not operated, the shooting mode selected the previous time remains effective. If no shooting mode has been selected in the past, the default mode AUTO is selected. If the menu button is not operated, the camera control unit 139 waits for the motion image trigger button 107 to be operated while adjusting the focus of the photographic lens as well as adjusting the exposure using the diaphragm mechanism in the lens-barrel. When the user decides on a composition and turns on the motion image trigger button 107 (Step 204), the video camera starts to shoot motion images (Step 205). When the user operates the motion image trigger button 107 again (Step 206), the video camera stops shooting motion images (Step 207) and resumes the focus adjustment of the photographic lens and the exposure adjustment which is performed using the diaphragm mechanism in the lens-barrel, according to the distance of the subject from the video camera and the luminance of the subject (Step 202).

With the shooting mode menu displayed by the operation of the menu button, when the user selects the LOW LIGHT mode by turning the shooting mode selection dial switch 109 and confirms it with the menu button 108 (Step 208), the camera control unit 139 compares a metered light value which represents the brightness of the subject with a predetermined value (Step 209). If the metered light value is lower than the predetermined value, the camera control unit 139 keeps the subject illuminating light 104 on (Step 210).

The subject illuminating light 104 is intended for shooting under low-light conditions, but even if the LOW LIGHT shooting mode is selected, the subject illuminating light 104 is not much use during photography in a relatively bright environment. Thus, if the photographic environment measured by the photographic lens 102 is brighter than predetermined illuminance, the subject illuminating light 104 is not turned on to cut unnecessary power consumption. Therefore, before turning on the subject illuminating light 104 (Step 210), the metered light value which represents the brightness of the subject is measured and compared with the value predetermined based on the brightness below which the subject illuminating light 104 has effect (Step 209). If the metered light value is lower than the predetermined value, the subject illuminating light 104 is set to be turned on (Step 210).

If the metered light value is higher than the value predetermined based on the brightness below which the subject illuminating light 104 has effect (Step 209), the camera control unit 139 keeps the subject illuminating light 104 off and waits for the motion image trigger button 107 to be operated. On the other hand, if the metered light value is lower than the predetermined value, the camera control unit 139 keeps the subject illuminating light 104 on (Step 210) and waits for the motion image trigger button 107 to be operated. In this condition, when the user decides on a composition and turns on the motion image trigger button 107 (Step 204), the video camera starts to shoot motion images (Step 205). When the user operates the motion image trigger button 107 again (Step 206), the camera control unit 139 turns off the subject illuminating light 104 (Step 211) if it is on, and stops shooting motion images (Step 207). Then, the camera control unit 139 resumes the focus adjustment of the photographic lens and the exposure adjustment which is performed using the diaphragm mechanism in the lens-barrel, according to the distance of the subject from the video camera and the luminance of the subject (Step 202). Also, it resumes waiting for the motion image trigger button 107 to be operated. To finish shooting, the user turns off the main power by returning the main power switch 105 to the neutral position shown in FIG. 4.

Next, still-image shooting will be described with reference to the flowcharts in FIGS. 8A and 8B. When the user turns on the main power by rotating the main power switch 105 counterclockwise by a predetermined amount and sets the Camera mode (Step 201), the camera control unit 139 instructs the image optical unit drive unit 138 to adjust the focus of the photographic lens and adjust the exposure using the diaphragm mechanism in the lens-barrel, according to the distance of the subject from the video camera and the luminance of the subject (Step 202). When the photographer decides on a composition and presses the still image trigger button 106 half-stroke (Step 303), the first signal is detected and the focus adjustment and exposure adjustment which have followed the distance to the subject and the luminance of the subject are locked (Step 304). Then, the camera control unit 139 judges whether the selected flash mode is the Flash ON mode or Flash OFF mode (Step 305). As described above, the selected flash mode changes in sequence among the Auto mode, Red-Eye Reduction mode, Flash ON mode and Flash OFF mode each time the flash mode button.

If it is judged that the selected flash mode is the Flash OFF mode, the camera control unit 139 judges whether the still image trigger button 106 is released (Step 309). If the still image trigger button 106 is released, the camera control unit 139 resumes the focus adjustment of the photographic lens and the exposure adjustment which is performed using the diaphragm mechanism in the lens-barrel, according to the distance of the subject from the video camera and the luminance of the subject (Step 202) and waits for the still image trigger button 106 to be operated. When the user presses the still image trigger button 106 full-stroke (Step 310) and the second signal is detected, the camera shoots a still image (Step 311).

If it is judged that the selected flash mode is not the Flash OFF mode, the camera control unit 139 judges whether the selected flash mode is the Flash ON mode (Step 306). If it is judged that the selected flash mode is the Flash ON mode, the camera control unit 139 judges whether the still image trigger button 106 is released (Step 312). If the still image trigger button 106 is released, the camera control unit 139 resumes the focus adjustment of the photographic lens and the exposure adjustment which is performed using the diaphragm mechanism in the lens-barrel, according to the distance of the subject from the video camera and the luminance of the subject (Step 202) and waits for the still image trigger button 106 to be operated. If the still image trigger button 106 is pressed full-stroke (Step 313) before it is released and if the second signal is detected, the flash unit 103 fires (Step 314) and the camera shoots a still image in synchronization with the firing of the flash unit 103 (Step 311).

If it is judged that the selected flash mode is not the-Flash ON mode (i.e., if it is either the Auto mode or Red-Eye Reduction mode), the camera control unit 139 compares a metered light value which represents the brightness of the subject with a predetermined value (Step 307). The predetermined value is a value above which correct exposure is available even if the flash unit is not fired. If the metered light value is lower than the predetermined value, it is necessary to fire the flash unit to obtain correct exposure. If the metered light value is higher than the predetermined value, there is no need to fire the flash unit and the video camera shoots a still image just like when the Flash OFF mode is set. That is, the camera control unit 139 judges whether the still image trigger button 106 is released (Step 315). If the still image trigger button 106 is released, the camera control unit 139 resumes the focus adjustment of the photographic lens and the exposure adjustment which is performed using the diaphragm mechanism in the lens-barrel (Step 202) and waits for the still image trigger button 106 to be operated. If the still image trigger button 106 is pressed full-stroke (Step 316) before it is released and if the second signal is detected, the camera shoots a still image (Step 311).

If the metered light value is lower than the predetermined value, the camera control unit 139 judges whether the selected flash mode is the Auto mode (Step 308). If it is judged that the selected flash mode is the Auto mode, the camera control unit 139 judges whether the still image trigger button 106 is released (Step 317). If the still image trigger button 106 is released, the camera control unit 139 resumes the focus adjustment of the photographic lens and the exposure adjustment which is performed using the diaphragm mechanism in the lens-barrel (Step 202) and waits for the still image trigger button 106 to be operated. If the still image trigger button 106 is pressed full-stroke (Step 318) before it is released and if the second signal is detected, the flash unit 103 fires (Step 319) and the camera shoots a still image in synchronization with the firing of the flash unit 103 (Step 311).

If it is judged that the selected flash mode is not the Auto mode (i.e., if the Red-Eye Reduction mode is selected), the camera control unit 139 keeps the subject illuminating light 104 on (Step 320). By keeping the subject illuminating light 104 on, it is possible to make the person contract his/her pupils when he/she is photographed, and thereby to reduce red-eye.

If the second signal is not detected within a predetermined time after the first signal is detected (Step 321), the continuous glow of the subject illuminating light 104 triggered by a half-stroke button press is stopped (Step 322) to conserve power. According to this embodiment, even if the continuous glow of the subject illuminating light 104 is stopped after the predetermined time elapses, a full-stroke press of the motion image trigger button 107 is accepted, but the distance or metered light value may have changed before the subject illuminating light 104 is turned off. Thus, to give priority to image quality, it is possible, as another embodiment, to resume the focus adjustment of the photographic lens and the exposure adjustment which is performed using the diaphragm mechanism in the lens-barrel (Step 202) after the continuous glow of the subject illuminating light 104 is stopped.

Incidentally, even if the Red-Eye Reduction mode is selected, the subject illuminating light 104 is not turned on if the metered light value of the subject is higher than the predetermined value. This is because the flash unit 103 is not fired when the metered light value of the subject is higher than the predetermined value, and thus, the red-eye phenomenon which would create the need to consume power on the subject illuminating light 104 does not occur in the first place.

After turning off the subject illuminating light 104, the camera control unit 139 judges whether the still image trigger button 106 is released (Step 323). If the still image trigger button 106 is released, the camera control unit 139 turns off the subject illuminating light 104 if it is on, resumes the focus adjustment of the photographic lens and the exposure adjustment which is performed using the diaphragm mechanism in the lens-barrel (Step 202), and waits for the still image trigger button 106 to be operated. If the still image trigger button 106 is pressed full-stroke (Step 325) before it is released and if the second signal is detected, the subject illuminating light 104 is stopped (Step 326), the flash unit is fired (Step 319), and a still image is shot in synchronization with the firing of the flash unit 103 (Step 311).

After the still image is shot, the camera control unit 139 resumes the focus adjustment of the photographic lens and the exposure adjustment which is performed using the diaphragm mechanism in the lens-barrel, according to the distance of the subject from the video camera and the luminance of the subject (Step 202). Also, it resumes waiting for the still image trigger button 106 to be operated. To finish shooting, the user turns off (137) the main power by returning the main power switch 105 to the neutral position as shown in FIG. 4.

Shooting modes which have no direct bearing on this embodiment are not limited by this embodiment and may be named and controlled as desired.

Although in this embodiment, the still image trigger button 106 for starting to shoot a still image and the motion image trigger button 107 for starting to shoot motion images are provided separately, alternatively it is possible to combine a still image trigger button and motion image trigger button into a single button and make shooting mode switchable between Still Image Shooting mode and Motion Image Shooting mode

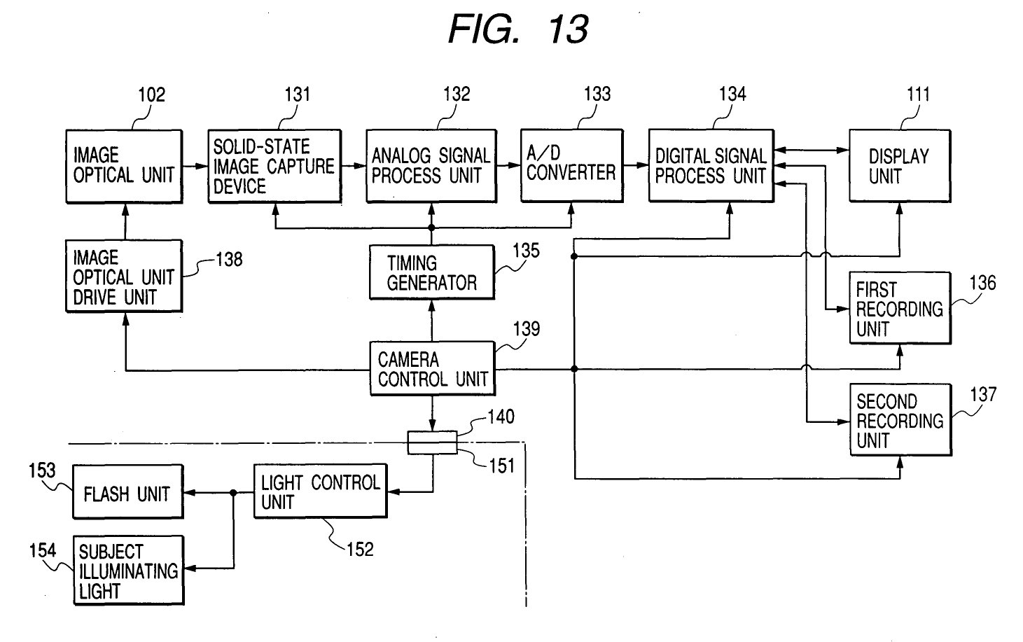

Also, although in this embodiment, the flash unit 103 and subject illuminating light 104 are incorporated in the video camera body 101, the flash unit 103 and subject illuminating light 104 may be attached externally to the video camera body 101. FIG. 13 shows a block diagram of a video camera equipped with an external illuminating device comprising a flash unit 153 and subject illuminating light 154.

The video camera and the external illuminating device are connected both mechanically and electrically via an interface 140 attached to the video camera and an interface 151 attached to the external illuminating device. Incidentally, it is not always necessary to connect the video camera and the external illuminating device mechanically and electrically, and they may be configured to communicate wirelessly. Reference numeral 152 denotes a light control unit which controls the external illuminating device and communicates with the camera control unit 139. Reference numerals 153 and 154 denote a flash unit and a subject illuminating light, respectively, contained in the external illuminating device. They emit light at control signals from the light control unit 152.

The light control unit 152 receives information such as the metered light value from the camera control unit 139, calculates flash light quantity for the flash unit 153, and wait for a flash command from the camera control unit 139. The flash command here is the first signal in response to a half-stroke press of the still image trigger button 106, second signal in response to a full-stroke press, or signal in response to an operation of the motion image trigger button 107. They are sent via the interface 140 and interface 151 by the camera control unit which has sensed operation of the still image trigger button 106 or motion image trigger button 107. As is the case with the embodiment described earlier, the flash unit 153 and subject illuminating light 154 are controlled according to the operations of the still image trigger button 106 and motion image trigger button 107. The flowcharts shown in FIGS. 7 and 8A, 8B are directly applicable to this video camera and external illuminating device.

The above configuration, which reduces red-eye by illuminating the subject with the subject illuminating light 104, can concentrate the flash energy of the flash unit 103 on light emission during still-image shooting, allowing effective use of the energy stored in the capacitor. This makes it possible to reduce the capacitance of the capacitor and simplify the flash control circuit, and thus reduce the cost of the capacitor compared to a flash unit which fires a preflash before shooting a still image to reduce red-eye. Also, the size reduction of the capacitor itself allows downsizing of the video camera body.

The above configuration, which reduces red-eye by illuminating the subject with the subject illuminating light 104 just before shooting a still image, can continue flashing for seconds, and thus reduce red-eye more efficiently than the type which reduces red-eye by preflashing a conventional flash unit for a few milliseconds before shooting a still image. Also, when shooting under low-light conditions, the above configuration makes it easier for the photographer to decide on a composition because the subject is illuminated for seconds before shooting a still image.

Also, since the subject illuminating light 104 separate from the flash unit 103 is used for red-eye reduction, unlike preflashing of a flash unit, the above configuration can prevent the subject from moving by mistaking a flash fired to reduce red-eye for a flash for shooting.

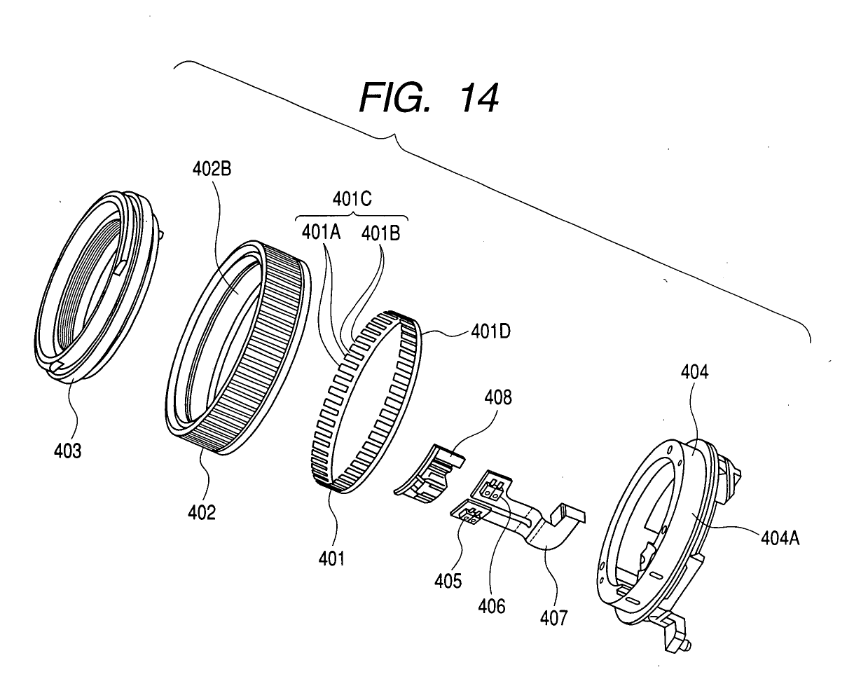

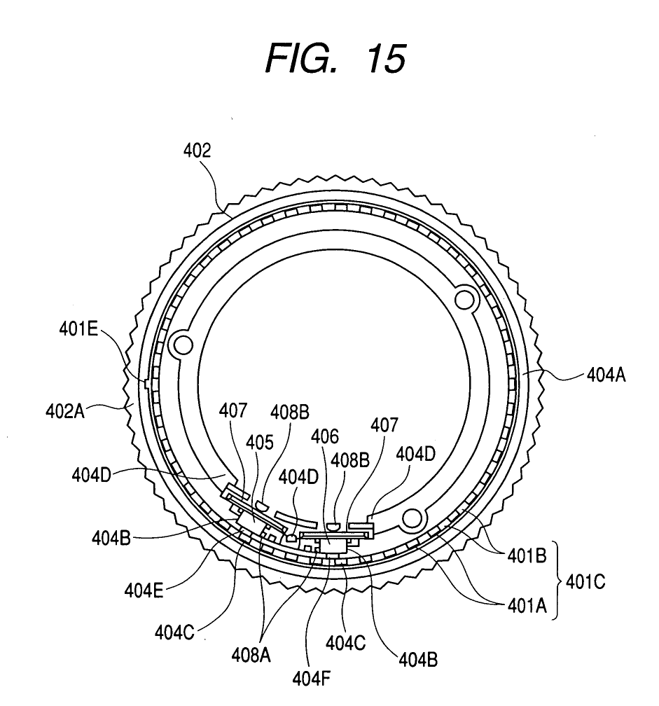

Next, description will be given of a configuration for detecting rotational position of the lens accurately. FIG. 14 is an exploded perspective view of a manual focusing unit for the lens. In particular, it shows a rotational operating member and rotation detecting unit which controls the lens driven by a motor in the video camera, using input signals from the manual focusing unit. FIG. 15 shows a cross section of the manual focusing unit.

In FIGS. 14 and 15, a rotational member 401 has a large number of teeth 401C which consist of alternating shading segments 401A and transparent segments 401B, where the shading segments 401A are impervious to light and the transparent segments 401B are spaces which are formed by adjacent shading segments and transmit light. The teeth 401C are secured by a ring 401D in such a way as to equally divide the circumference. A manual operating member 402, which can be rotated manually by the user, has its periphery shaped in such a way as to prevent slippage. It is made of metal such as aluminum and its inner surface is constituted by a reflecting surface 402B with high reflectance. As shown in FIG. 15, the rotational member 401 is provided with a key 401E, which fits in a key groove 402A in the manual operating member to make the two members rotate integrally by preventing relative rotation.

A rotation support member 403 has a mating part over which the manual operating member 402 fits and rotates. A position adjuster 404 has a mating part 404A over which the rotational member fit rotatably. It also has element contour contacts described later and is coupled with the rotation support member to determine the arrangement of the entire manual focusing unit. A first photoreflector 405 and second photoreflector 406 are mounted on a flexible substrate 407, in which there is a notch between the two elements to allow them to be laid out freely. A positioning member 408 has elastic pressers 408A and 408B to press the element contours against the contacts.

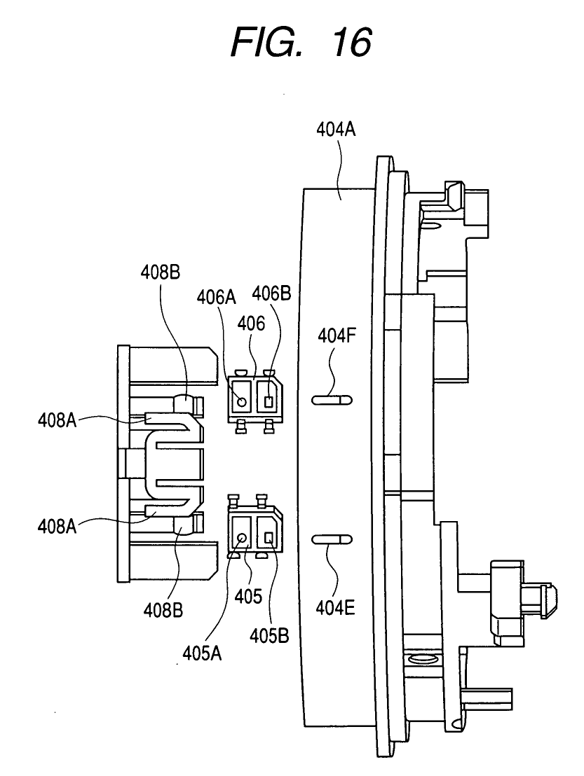

The rotational member 401 is positioned axially between the rotation support member 403 and position adjuster 404 together with the manual operating member 402. Reference numeral 404B denotes a circumferential element contour contact and reference numeral 404C denotes a radial element contour contact. Reference numeral 408A denotes a circumferential elastic presser mounted on the positioning member 408 while reference numeral 408B denotes a radial elastic presser. Reference numeral 404D denotes a support which accepts the positioning member. The elastic presser 408B is capable of elastic deformation perpendicular to the paper in FIG. 16 (in the radial direction in reality). When the manual focusing unit is assembled, the positioning member 408 positions the elements 405 and 406 by pressing them radially outward against the contact 404C, being supported by the support 404D.

The rotational member 401 fits over the mating part 404A of the position adjuster 404 and its teeth 401C pass outside the slits 404E and 404F as the rotational member 401 rotates. The slits, which are narrower than the shading segments, can shade the slits completely. When the manual operating member 402 is rotated manually, the rotational member 401 inside it rotates together, with the shading segments 401A and transparent segments 401B shading and revealing the slits alternately. Light from light emitters of the photoreflectors passes through the slits, passes through the transparent segments if they are on the outer circumference, is reflected by the reflecting surface 402B on the inner circumference of the manual operating member 402 outside the rotational member 401, and enters a light receiving part. If the shading segments are on the outer circumference, the reflected light is blocked and hardly enters the light receiving part.

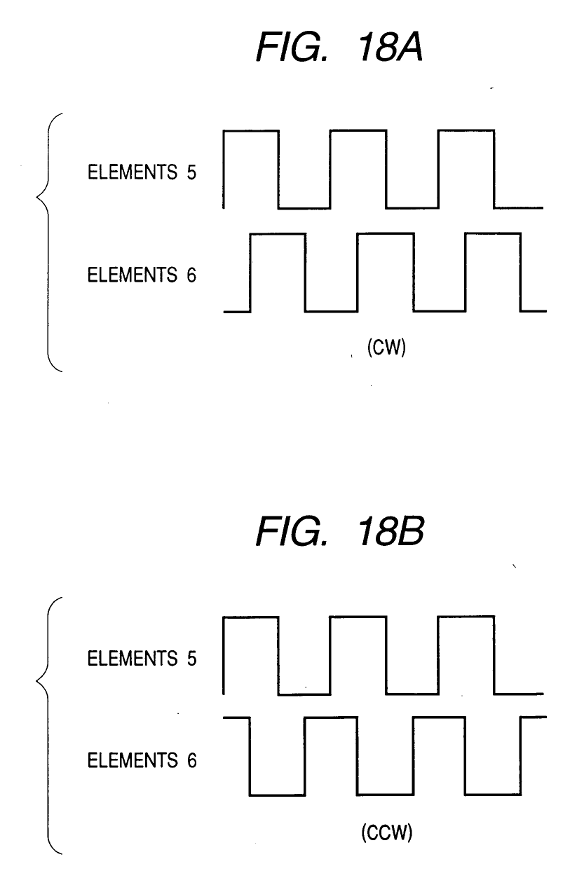

Consequently, when the operating member is rotated, the photoreflectors produce cyclic output, and pulsed output is obtained through a Schmitt trigger circuit. Also, the above configuration eliminates the need for space between the teeth and operating member, making it possible to implement a radially thin detector. According to this embodiment, there are 45 teeth on the circumference and each of the shading or transparent segments corresponds to 4 degrees, meaning that a rotation of 8 degrees produces one pulse cycle. The slits 404E and 404F are 30 degrees apart from each other in the direction of rotation and their pulses are 3 and ¾ cycles out of phase with each other. FIGS. 18A and 18B show pulse signals obtained from the photoreflectors when the operating member is rotated.

Referring to FIG. 15, when the operating member is rotated clockwise, the pulse signal from the element 405 leads the pulse signal from the element 406 by ¼ cycle as shown in FIG. 18A. When the operating member is rotated counterclockwise, the pulse signal from the element 405 lags the pulse signal from the element 406 by ¼ cycle as shown in FIG. 18B. The phase lead or lag tells the rotational direction of the operating member, and the number of pulses tells the amount of rotation. When the slits are 30 degrees apart, a 51-teeth operating member which has 6 teeth more than the 45-teeth operating member of this embodiment produces a phase difference of 4 and ¼ cycles and a 39-teeth operating member produces a phase difference of 3 and ¼ cycles. In this way, the phase difference between the pulse signals can be varied by varying the number of teeth.

To detect the phase difference between the pulse signals shown in FIGS. 18A and 18B, the photoreflectors must be positioned accurately. The toothed operating member and the position adjuster are plastic moldings. Thus, it is possible to accurately form the width, pitch, etc. of the teeth on the operating member; the width and spacing of the slits in the position adjuster; and the contacts for sensors. However, photoreflectors, which are mounted on a substrate, have conventionally required a lot of man-hours and costs for positioning. For example, when soldering a sensor to a substrate, first the sensor is soldered to the substrate with the sensor and substrate placed in a positioning jig in order to position the sensor, the sensor and substrate are removed from the jig, and the substrate is secured to the body with screws while at the same time positioning the sensor finally. Fundamentally, to position the sensor most accurately, it is best to position the sensor based on the external shape of the sensor itself.

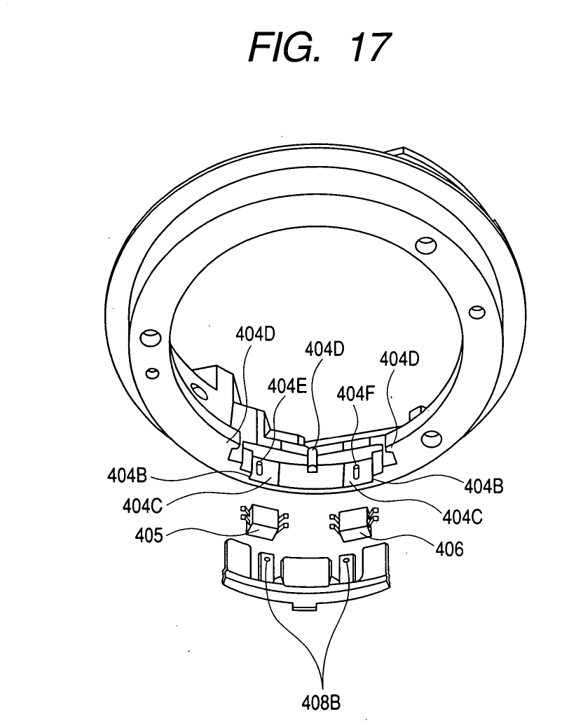

Referring to FIG. 17, the spacings between the slits 404E and 404F, between the slit 404E and element contour contact 404B, and between the slit 404F and element contour contact 404B are provided accurately on the position adjuster which is a molding. The photoreflectors 405 and 406 are mounted on the flexible substrate, which is notched to provide for freedom of layout. The photoreflectors 405 and 406 are incorporated into the position adjuster 404, having been mounted on the flex-board. Once the positioning member 408 is installed with its circumferential elastic presser 408A. inserted between the photoreflectors 405 and 406, the two elements are energized in such a way as to move away from each other in the circumferential direction, their contours are pressed against the contact 404B, and the two elements are secured being positioned in such a way that their light emitters and light receiving parts match the slits 404E and 404F accurately.

By pressing the inner sides of the flexible substrate 407 on which the photoreflectors 405 and 406 are mounted, the radial elastic presser 408B of the positioning member presses the photoreflectors 405 and 406 radially outward via the flex-board 407. Consequently, the elements 405 and 406 are positioned accurately with their contours against the contact 404C of the position adjuster. The slits are slightly longer than the spacing between the light-emitting parts and light receiving parts of the photoreflectors. The teeth are also long enough to cover the slits. Therefore, detection accuracy is not affected by slight variations of the elements in the direction of the rotational axis of the rotational member.

Although the above embodiments have been described citing a rotation detector which detects the direction and amount of rotation of the rotational member, the present invention can be applied similarly to a displacement detector which detects the direction and amount of travel of a moving member which changes its position along a straight line.

What is claimed is:

1. An imaging device, comprising:
a mode setting member which allows a plurality of shooting modes to be set;
a first trigger member for shooting still images; and
a second trigger member for shooting motion images,
wherein the mode setting member allows at least a first shooting mode and a second shooting mode to be set,
the first shooting mode shoots a still image by causing a first light emitter to emit light continuously when a first operation signal from the first trigger member is detected and causing the first light emitter to stop emitting light and causing a second light emitter to emit light when a second operation signal from the first trigger member is detected, and
the second shooting mode, upon detecting an operation signal from the second trigger member, starts shooting motion images while causing a first light emitter to keep emitting light continuously.

2. The imaging device according to claim 1, wherein:
the mode setting member allows a third shooting mode to be selected; and
the third shooting mode does not cause the first light emitter to emit light continuously even if the first operation signal from the first trigger member is detected, and shoots a still image by causing the second light emitter to emit light continuously when the second operation signal from the first trigger member is detected.

3. An imaging device capable of shooting motion images and still images, comprising:
a first light emitter capable of emitting light continuously during motion-image shooting;
a second light emitter capable of emitting light during still-image shooting; and
a control circuit which controls the first light emitter and the second light emitter,
wherein when a predetermined still-image shooting mode is selected, the control circuit causes the first light emitter to emit light continuously before causing the second light emitter which operates in synchronization with still-image shooting to emit light.

4. The imaging device according to claim 3, wherein the control circuit causing the second light emitter to emit light after causing the first light emitter to stop emitting light continuously.

5. An imaging device which can communicate with an illuminating device equipped with a first light emitter capable of emitting light continuously and a second light emitter capable of emitting flashing light and which can control light emissions of the illuminating device by sending signals to the illuminating device, the imaging device comprising:
a control circuit which sends flash command signals to the first light emitter and second light emitter,
wherein when a predetermined motion-image shooting mode is selected, the control circuit sends the illuminating device a signal for causing the first light emitter to emit light continuously, and when a predetermined still-image shooting mode is selected, the control circuit sends the illuminating device a signal for causing the first light emitter to emit light continuously before sending the illuminating device a signal for causing the second light emitter which operates in synchronization with still-image shooting to emit light.

6. An illuminating device which can communicate with an imaging device comprising a first trigger member for starting to shoot a still image and a second trigger member for starting to shoot motion images and which emits light based on signals sent from the imaging device, the illuminating device comprising;
a first light emitter capable of emitting light continuously;
a second light emitter capable of emitting flashing light; and
a control circuit which controls the first light emitter and the second light emitter,
wherein the control circuit:
causes the first light emitter to emit light continuously when a first signal is received from the imaging device in response to an operation of the first trigger member, causes the second light emitter to emit light after causing the first light emitter to stop emitting light continuously when a second signal is received in response to an operation of the first trigger member, and
causes the first light emitter to emit light continuously when a signal is received from the imaging device in response to an operation of the second trigger member.

7. An illuminating device which can communicate with an imaging device capable of shooting motion images and still images and which emits light based on signals sent from the imaging device, the illuminating device comprising;
a first light emitter capable of emitting light continuously during motion-image shooting;
a second light emitter capable of emitting flashing light during still-image shooting; and
a control circuit which controls the first light emitter and the second light emitter,
wherein when a predetermined still-image shooting mode is selected on the imaging device, the control circuit causes the first light emitter to emit light continuously before causing the second light emitter which operates in synchronization with still-image shooting to emit light.

8. The imaging device according to claim 3, wherein the first light emitter has its periphery elevated.

9. The imaging device according to claim 3, wherein the first light emitter has a light-emitting element, condensing lens and diffuser which diffuses light from a light source placed between the light-emitting element and condensing lens.
